(19) United States
(12) Patent Application Publication
(10) Pub. No.: US 2004/0121682 A1
(43) Pub. Date: Jun. 24, 2004

(54) Antimicrobial fibrous substrates

(75) Inventors: Roger Bradshaw Quincy, Cumming, GA (US); Elizabeth Deibler Gadsby, Marietta, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/328,707

(22) Filed: Dec. 23, 2002

(51) Int. Cl. B32B 5/02; B32B 27/04; B32B 27/12; D04H 1/00; D04H 3/00; D04H 5/00; D04H 13/00; B32B 5/26; B32B 5/16

(52) U.S. Cl. 442/123; 442/121; 442/417; 442/381

(57) ABSTRACT

A fibrous substrate that retains good antimicrobial efficacy over an extended period of time and that does not result in a substantial increase in odor production is provided. Specifically, the fibrous substrate contains a halogenated antimicrobial agent and an odor adsorbent to reduce the level of odors often associated with halogenated antimicrobial agents. For example, in one embodiment, the halogenated antimicrobial agent includes a heterocyclic N-halamine compound, while the odor adsorbent is selected from the group consisting of activated carbon, zeolites, silica, alumina, magnesia, titania, clay, cyclodextrin and derivatives thereof, and the like. The fibrous substrate may also be substantially free from superabsorbents to improve antimicrobial efficacy over time.

### BACKGROUND OF THE INVENTION

Nonwoven webs used in personal care absorbent articles can harbor bacteria, particularly when in contact with bodily fluids. Consequently, antimicrobial agents have been used in an attempt to reduce or prevent bacteria growth. However, various problems exist with using some antimicrobial agents in absorbent articles. For instance, halogenated antimicrobial agents have been used in several applications to prevent bacteria growth. Unfortunately, at least some of the halogen groups (e.g., chlorine) of the antimicrobial agent leach out of the agent over time and produce an undesired odor, such as the smell of chlorine. In addition, the antimicrobial efficacy of the antimicrobial agent is also typically reduced over time.

As such, a need exists for antimicrobial absorbent articles that can inhibit the growth of bacteria over an extended period of time without producing a substantial odor.

### SUMMARY OF THE INVENTION

In accordance with one embodiment of the present invention, a fibrous substrate is disclosed. The fibrous substrate is applied with a halogenated antimicrobial agent in an amount from about 0.1% to about 10% by weight of the substrate, and in some embodiments, from about 0.5% to about 5% by weight of the substrate. For example, the halogenated antimicrobial agent may be selected from the group consisting of N-halamines, iodinated resins, and combinations thereof. In one embodiment, an N-halamine compound may be utilized that is obtained from a 1,3-dimethylol-5,5-dimethyl hydantoin precursor. In another embodiment, an N-halamine compound may be utilized that is obtained from a polystyrene hydantoin precursor. For example, one type of N-halamine compound that may be utilized has the following formula:

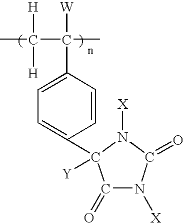

wherein,

W=hydrogen or CH₃;

X=hydrogen, a halogen atom (e.g., Cl or Br), or a C₁-C₄ alkyl group; and

Y=a C₁-C₄ alkyl group.

Besides containing a halogenated antimicrobial agent, the fibrous substrate also contains an odor adsorbent in an amount of 0.5% to about 20% by weight of said substrate, and in some embodiments, from about 1% to about 10% by weight of the substrate. For example, the odor adsorbent may be selected from the group consisting of activated carbon, zeolites, silica, alumina, magnesia, titania, clay, cyclodextrin and derivatives thereof, and so forth. Through the use of an odor adsorbent, such as described above, odoriferous compounds often associated with halogenated antimicrobial agents can be adsorbed and neutralized. Likewise, the odor adsorbents may also adsorb and neutralize odiferous compounds not associated with the antimicrobial agent, but with other materials (e.g., biological fluids) with which it often contacts.

In addition, the fibrous substrate may also exhibit good antimicrobial efficacy over an extended period of time. In particular, after being aged at a temperature of 130° F. and a relative humidity of 50% for 2 weeks, the fibrous substrate exhibits a log reduction for E. coli, S. aureus, P. mirabilis, or combinations thereof, of at least about 3, measured after a contact period of 4 hours. Further, in some embodiments, the aged log reduction may be at least about 3.5, and in some embodiments, at least about 4.

In accordance with another embodiment of the present invention, a personal care absorbent article is disclosed that comprises at least one liquid-transmissive layer and a liquid-absorbent core. A nonwoven web that contains an N-halamine compound and an odor adsorbent forms at least a portion of the liquid-transmissive layer, the liquid-absorbent core, or combinations thereof. After being aged at a temperature of 130° F. and a relative humidity of 50% for 2 weeks, the nonwoven web exhibits a log reduction for E. coli, S. aureus, P. mirabilis, or combinations thereof, of at least about 3, measured after a contact period of 4 hours.

Other features and aspects of the present invention are discussed in greater detail below.

Detailed Description of Representative Embodiments

### Definitions

As used herein, an “absorbent article” refers to any article capable of absorbing water or other fluids. Examples of some absorbent articles include, but are not limited to, personal care absorbent articles, such as diapers, training pants, absorbent underpants, adult incontinence products, feminine hygiene products (e.g., sanitary napkins), swim wear, baby wipes, and so forth; medical absorbent articles, such as garments, fenestration materials, underpads, bandages, absorbent drapes, and medical wipes; food service wipers; clothing articles; and so forth. Materials and processes suitable for forming such absorbent articles are well known to those skilled in the art.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, etc.

As used herein, the term “meltblowing” refers to a process in which fibers are formed by extruding a molten thermoplastic material through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that may be continuous or discontinuous, are generally smaller than 10 microns in diameter, and are generally tacky when deposited onto a collecting surface.

As used herein, the term “spunbonding” refers to a process in which small diameter substantially continuous fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spun-bonded nonwoven webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levv, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers can sometimes have diameters less than about 40 microns, and are often between about 5 to about 20 microns.

### DETAILED DESCRIPTION

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

In general, the present invention is directed to an antimicrobial fibrous substrate that retains good antimicrobial efficacy over an extended period of time and that does not result in a substantial increase in odor production. Specifically, the fibrous substrate contains a halogenated antimicrobial agent and an odor adsorbent to reduce the level of odors often associated with halogenated antimicrobial agents. For example, in one embodiment, the halogenated antimicrobial agent includes a heterocyclic N-halamine compound that contains one or more nitrogen atoms, while the odor adsorbent is selected from the group consisting of activated carbon, zeolites, silica, alumina, magnesia, titania, clay, cyclodextrin and derivatives thereof, and so forth. The fibrous substrate may also be substantially free from superabsorbents to improve antimicrobial efficacy over time.

Generally speaking, any of a variety of halogenated antimicrobial agents may be used in the present invention. For example, one halogenated antimicrobial agent that can be used in the present invention is an N-halamine compound. As used herein, the term “N-halamine” generally refers to a heterocyclic membered ring. N-halamines are generally well known in the art and are described, for instance, in U.S. Pat. No. 5,490,983 to Worley, et al.; U.S. Pat. No. 5,882,357 to Sun, et. al., U.S. Pat. No. 6,162,452 to Worley, et al.; and U.S. Publication 2002/0077612 to Quincy, Ill., which are incorporated herein in their entirety by reference thereto for all purposes. For instance, in some embodiments, the N-halamine compound is a 4 to 7 membered ring in which at least 3 members of the ring are carbon, from 1 to 3 members of the ring are nitrogen, and from 0 to 1 member of the ring is oxygen. Further, the members of the N-halamine ring structure are often substituted with various moieties. For instance, in some embodiments, from 0 to 2 carbon members are substituted with a carbonyl group and from 1 to 3 nitrogen atoms are substituted with a hydrogen, hydroxyalkyl group (e.g., —CH₂OH), or a alkoxyalkyl group (e.g., —CH₂OCH₃). The ring members may be further substituted with alkyl groups (e.g., methyl, ethyl, etc.) or hydroxy groups. In addition, at least one nitrogen of the ring structure is bonded to a halogen atom.

N-halamines may be obtained by exposing a hydantoin (a 5-membered ring with nitrogen) to a source of halogen, such as sodium hypochlorite, chlorine, bromine, etc., as is well known to one of ordinary skill in the art. For instance, some N-halamine precursor materials suitable for use in the present invention include, but are not limited to, monomethylol-5,5-dimethyl (MDM) hydantoin, 1,3-dimethylol-5,5-dimethyl (DMDM) hydantoin, monomethylolated and dimethylolated derivatives of 2,2,5,5-tetramethyl-1,3-imidazolidin-4-one, 6,6-dimethyl-1,3,5-triazine-2,4-dione, 4,4,5,5-tetramethyl-1,3-imidazolidin-2-one, cyanuric acid and 5,5-dimethylhydantoin; and monomethoxylated and dimethoxylated derivatives of monomethylolated and dimethylolated derivatives of 2,2,5,5-tetramethyl-1,3-imidazolidin-4-one, 6,6-dimethyl-1,3,5-triazine-2,4-dione, 4,4,5,5-tetramethyl-1,3-imidazolidin-2-one, cyanuric acid, 5,5-dimethylhydantoin. Examples of the monomethoxylated and dimethoxylated compounds are monomethoxymethyl-5,5-dimethylhydantoin and 1,3-dimethoxymethyl-5,5-dimethylhydantoin, respectively. Such N-halamine precursors are commercially available from a number of different sources. For instance, monomethylol-5,5-dimethyl (MDM) hydantoin and 1,3-dimethylol-5,5-dimethyl (DMDM) hydantoin are commercially available under the tradenames DANTOIN® and GLYDANT®) XL-1000, respectively, from Lonza, Inc. (Fair Lawn, N.J.).

One particular example of a suitable N-Halamine precursor material is dimethyloyldimethyl (DMDM) hydantoin, which is available from McIntyre Group, Ltd., of Park Forest, Ill., under the tradename MACKSTAT® DM. DMDM hydantoin has the following formula (1):

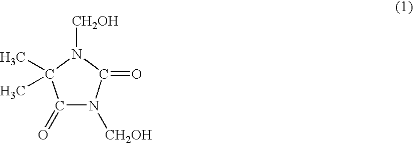

DMDM hydantoin is compatible with anionic, cationic, nonionic, and amphoteric surfactants, as well as with proteins, aloe, cationic and nonionic polymers, amines, and so forth, and thus can be applied topically to a wide variety of materials.

Another example of a suitable N-halamine precursor material is polystyrene hydantoins, such as those having the general formula (C₁₂H₁₂N₂O₂)ₙ. In some embodiments, for instance, a polystyrene hydantoin precursor is halogenated to result in an N-halamine having the following general formula (2):

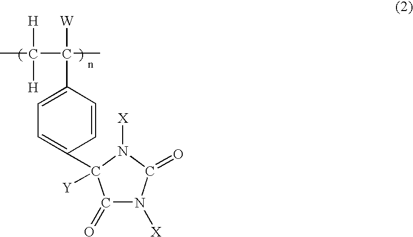

wherein,

W hydrogen or CH₃;

X=hydrogen, a halogen atom (e.g., Cl or Br), or a C₁-C₄ alkyl group; and

Y=a C₁-C₄ alkyl group.

For example, in one embodiment, the formula (3) may be poly[1,3-dichloro-5-methyl-5(4′-vinylphenyl)hydantoin], which is available from HaloSource, inc. of Seattle, Wash. under the name “Poly-1-Cl.” The structure of “Poly-1-Cl” is set forth below as formula (3):

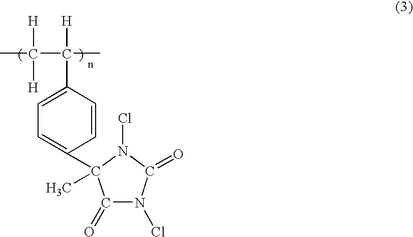

One benefit of the N-halamines set forth above in formulae (2) and (3) is that they do not generally release chlorine during the time in which they are stored and utilized. To improve stability, the halogen group may be positioned only on the amide nitrogen. In some instances, halogen atoms present at other locations on the polymer (e.g., imide nitrogen) may be less stable. Thus, in most embodiments, at least about 90%, in some embodiments at least about 95%, and in some embodiments, at least about 99% of the total halogen atoms in the halogenated polystyrene hydantoin are chemically linked to the amide nitrogens in the polymer. Further, odor control is typically enhanced with an increase in amide sites that are halogenated. Thus, in some embodiments, the percentage of amide nitrogens of the polymer that are halogenated is from about 10 to 100%, in some embodiments from about 50 to 100%, and in some embodiments, from about 75 to 100%.

Besides N-halamines, it should also be understood that other halogenated antimicrobial agents may also be used in the present invention. For instance, an iodinated resin may be used as the antimicrobial agent, such as described in U.S. Pat. No. 5,639,452 to Messier and U.S. Pat. No. 6,045,820 to Messier, which are incorporated herein in their entirety by reference thereto for all purposes. Commercially available examples of such iodinated resins are available under the trade name “Triosyn” from Triosyn Inc. of St Jerome, Quebec, Canada.

Despite the relative stability that can be achieved by utilizing some types of halogenated antimicrobial agents, such as those described above, some of the halogen groups (e.g., chlorine) of the antimicrobial agent still leach out of the agent after an extended period of time. Such leaching of the halogen groups may cause a variety of undesired effects. For instance, without being limited in theory, it is believed that the halogen groups, particularly those that have leached out of the antimicrobial agent, undergo oxidation reactions with organic compounds present in biological fluids. As an example, chlorine groups may react with amines to form odorous chloramine compounds. Thus, in accordance with the present invention, odor adsorbents may be utilized in conjunction with the antimicrobial agent to reduce unwanted odors. Through the use of an odor adsorbent, the odoriferous compounds associated with halogenated antimicrobial agents can be adsorbed and neutralized. Likewise, the odor adsorbents may also adsorb and neutralize odiferous compounds not associated with the antimicrobial agent, but with other materials (e.g., biological fluids) with which it often contacts. For instance, the odor adsorbent may adsorb odiferous compounds such as dimethyldisulphide (DMDS), triethylamine (TEA), ammonia, etc.

Some examples of odor adsorbents that may be used in the present invention include, but are not limited to, activated carbon, zeolites, silica, alumina, magnesia, titania, clay (e.g., smectite clay), cyclodextrin and derivatives thereof, combinations thereof, and so forth. For instance, suitable forms of activated carbon and techniques for formation thereof are described in U.S. Pat. No. 5,834,114 to Economy, et al.; WO 01/97972 to Economy, et al.; and U.S. Patent Publication No. 2001/0024716, which are incorporated herein in their entirety by reference thereto for all purposes. Some commercially available examples of activated carbon are made from saw dust, wood, charcoal, peat, lignite, bituminous coal, coconut shells, and so forth. One particular example of activated carbon that may be used in the present invention is Nuchar® RGC 40, a granular activated carbon available from MeadWestvaco Corp. RGC 40 can be obtained with a U.S. Mesh Size of 40×100 (150 to 425 microns), and can be ground to any desired median particle size, such as about 1 micron.

Further, odor-adsorbing forms of zeolites are also well known in the art. For instance, zeolites generally have an aluminate/silicate framework, with associated cations, M, providing overall electrical neutrality. Empirically, the zeolite framework can be represented as follows:

xAlO₂.ySiO₂

with the electrically neutral zeolite represented as follows:

x/n M.xAlO₂.ySiO₂. zH₂O

wherein, x and y are each integers, M is a cation, and n is the charge on the cation. As noted by the empirical formula, zeolites may also contain water (zH₂O). M can be a wide variety of cations, e.g., Na⁺, K⁺, NH₄⁺, alkylammonium, heavy metals, and so forth. Still other forms of suitable zeolites may be described in U.S. Pat. No. 6,096,299 to Guarracino, et al., which is incorporated herein in its entirety by reference thereto for all purposes. Moreover, some examples of cyclodextrins that may be suitable for use in the present invention include, but are not limited to, α-cyclodextrin, hydroxyalkyl α-cyclodextrin, alkyl α-cyclodextrin, β-cyclodextrin, hydroxyalkyl β-cyclodextrin, alkyl β-cyclodextrin, γ-cyclodextrin, hydroxyalkyl γ-cyclodextrin, and alkyl γ-cyclodextrin.

Generally speaking, the halogenated antimicrobial agent and odor adsorbent, such as described above, are applied to a fibrous substrate of an absorbent article, either separately or as a mixture. The amount of each additive may vary depending on the nature of the fibrous substrate and the intended application. However, in most embodiments, the antimicrobial agent will constitute from about 0.1 to about 10 wt. % of the fibrous substrate, in some embodiments from about 0.5 to about 10 wt. % of the fibrous substrate, and in some embodiments, from about 1 to about 3 wt. % of the fibrous substrate. Likewise, the odor adsorbent will constitute from about 0.5 to about 20 wt. % of the fibrous substrate, in some embodiments from about 1 to about 10 wt. % of the fibrous substrate, and in some embodiments, from about 2 to about 5 wt. % of the fibrous substrate.

The antimicrobial agent and odor adsorbent may be applied to the fibrous substrate using any of a variety of well-known application techniques. For instance, the antimicrobial agent and/or odor adsorbent may be incorporated within the matrix of the fibrous substrate and/or applied to the surface thereof. Suitable techniques for application such materials to a fibrous substrate include printing, spraying, melt extruding, solvent coating, and so forth. In one particular embodiment, the antimicrobial agent and/or odor adsorbent are dispersed within the fibers during formation of the substrate.

Any of a variety of different fibrous substrates may be incorporated with the halogenated antimicrobial agent and odor adsorbent in accordance with the present invention. For instance, nonwoven fabrics, woven fabrics, knit fabrics, wet-strength paper, etc., may be applied with halogenated antimicrobial agent and odor adsorbent. When utilized, the nonwoven fabrics may include, but are not limited to, spunbonded webs (apertured or non-apertured), meltblown webs, bonded carded webs, air-laid webs, coform webs, hydraulically entangled webs, and so forth.

In many cases, the fibrous substrate will form all or a portion of an absorbent article. Absorbent articles commonly include a liquid-transmissive bodyside liner, a liquid-transmissive surge layer below the bodyside liner, a liquid-absorbent core below the surge layer, and a moisture vapor permeable, liquid impermeable outer cover below the absorbent core. In some embodiments, the treated fibrous substrate of the present invention may be employed as any one or more of the liquid transmissive (non-retentive) and absorbent layers. An absorbent core of the absorbent article, for instance, may be formed from an absorbent nonwoven web that includes a matrix of hydrophilic fibers. In one embodiment, the absorbent web may contain a matrix of cellulosic fluff fibers. One type of fluff that may be used in the present invention is identified with the trade designation CR1654, available from U.S. Alliance, Childersburg, Ala., U.S.A., and is a bleached, highly absorbent sulfate wood pulp containing primarily soft wood fibers. In another embodiment, the absorbent nonwoven web may contain a hydoentangled web. Hydroentangling processes and hydroentangled composite webs containing various combinations of different fibers are known in the art. A typical hydroentangling process utilizes high pressure jet streams of water to entangle fibers and/or filaments to form a highly entangled consolidated fibrous structure, e.g., a nonwoven fabric. Hydroentangled nonwoven fabrics of staple length fibers and continuous filaments are disclosed, for example, in U.S. Pat. No. 3,494,821 to Evans and U.S. Pat. No. 4,144,370 to Bouolton, which are incorporated herein in their entirety by reference thereto for all purposes. Hydroentangled composite nonwoven fabrics of a continuous filament nonwoven web and a pulp layer are disclosed, for example, in U.S. Pat. No. 5,284,703 to Everhart, et al. and U.S. Pat. No. 6,315,864 to Anderson, et al., which are incorporated herein in their entirety by reference thereto for all purposes.

Another type of suitable absorbent nonwoven web is a coform material, which is typically a blend of cellulose fibers and meltblown fibers. The term “coform” generally refers to composite materials comprising a mixture or stabilized matrix of thermoplastic fibers and a second non-thermoplastic material. As an example, coform materials may be made by a process in which at least one meltblown die head is arranged near a chute through which other materials are added to the web while it is forming. Such other materials may include, but are not limited to, fibrous organic materials such as woody or non-woody pulp such as cotton, rayon, recycled paper, pulp fluff and also superabsorbent particles, inorganic absorbent materials, treated polymeric staple fibers and so forth. Some examples of such coform materials are disclosed in U.S. Pat. No. 4,100,324 to Anderson, et al.; U.S. Pat. No. 5,284,703 to Everhart, et al.; and U.S. Pat. No. 5,350,624 to Georger, et al.; which are incorporated herein in their entirety by reference thereto for all purposes.

The halogenated antimicrobial agent and odor adsorbent may also be applied to a liquid transmissive layer of the absorbent article, such as the bodyside liner or surge layer. Such liquid transmissive layers are typically intended to transmit liquid quickly, and thus generally do not retain or absorb significant quantities of aqueous liquid. Materials that transmit liquid in such a manner include, but are not limited to, thermoplastic spunbonded webs, meltblown webs, bonded carded webs, air laid webs, and so forth. A wide variety of thermoplastic materials may be used to construct these non-retentive nonwoven webs, including without limitation polyamides, polyesters, polyolefins, copolymers of ethylene and propylene, copolymers of ethylene or propylene with a C₄-C₂₀ alpha-olefin, terpolymers of ethylene with propylene and a C₄-C₂₀ alpha-olefin, ethylene vinyl acetate copolymers, propylene vinyl acetate copolymers, styrene-poly(ethylene-alpha-olefin) elastomers, polyurethanes, A-B block copolymers where A is formed of poly(vinyl arene) moieties such as polystyrene and B is an elastomeric midblock such as a conjugated diene or lower alkene, polyethers, polyether esters, polyacrylates, ethylene alkyl acrylates, polyisobutylene, poly-1-butene, copolymers of poly-1-butene including ethylene-1-butene copolymers, polybutadiene, isobutylene-isoprene copolymers, and combinations of any of the foregoing.

The antimicrobial fibrous substrate of the present invention is generally capable of inhibiting the growth of a wide variety of microbes without resulting in a substantial increase in odor production. Specifically, it has been discovered that the antimicrobial fibrous substrate is particularly effective in killing both gram positive and gram negative bacteria when contacted therewith. The table below lists several types of bacteria that may be effectively killed by the antimicrobial substrate of the present invention. The table includes the name of the bacteria, the ATCC (American Type Culture Collection) identification number, and the abbreviation for the name of the organism used hereafter.

| Organism | ATCC # | Abbreviation |
|---|---|---|
| Staphylococcus aureus | 6538 | S. aureus |
| Escherichia coli | 8739 | E. coli |
| Klebsiella pneumoniae | 10031 | K. pneum. |
| Salmonella choleraesuis | 10708 | S. choler. |
| Proteus mirabilis | 4630 | P. mirabilis |

It has been discovered that the antimicrobial fibrous substrate of the present invention can achieve good antimicrobial efficacy even after an extended period of time. For example, even after an extended period of time, the antimicrobial fibrous substrate of the present invention can provide a log reduction for S. aureus, P. mirabilis, and/or E. coli of at least about 3, in some embodiments at least about 3.5, and in some embodiments, at least about 4. As is well known in the art, log reduction can be determined from the % bacteria population killed by the substrate according to the following correlations:

| % Reduction | Log Reduction |
|---|---|
| 90 | 1 |
| 99 | 2 |
| 99.9 | 3 |
| 99.99 | 4 |
| 99.999 | 5 |
| 99.9999 | 6 |

The specific log reduction is calculated from the % reduction according to the following formula:

Log Reduction=log[1/1−(% reduction/100)]

$$Log Reduction = log [ 1 / 1 - ( \% reduction \text{/} 100 ) ]$$

$$Where , \% reduction = \frac{\begin{matrix}[ \# of initial bacteria - \\ \# of bacteria remaining ]\end{matrix}}{\# of initial bacteria} \times 100$$

Moreover, the log reduction of a substrate over an extended period of time may generally be determined using “normal” or “accelerated” aging techniques. For instance, the substrate may be subjected to “normal aging”, in which the sample is stored for 8 weeks at room temperature and standard relative humidity (e.g., 70° F. and 50% relative humidity). Upon aging, the antimicrobial efficacy may be tested after a brief time period (e.g., 4 hours) during which the substrate is left in contact with the microbes. Alternatively, the substrate may be subjected to “accelerated aging”, in which the sample is stored for 2 weeks at 130° F. and 50% relative humidity before testing the antimicrobial efficacy of the substrate as described above. It should be understood that other techniques may also be utilized to determine the “aged” log reduction for the antimicrobial substrate. For example, in one embodiment, a hybrid of the techniques mentioned above may be utilized in which the substrate is subjected to 6 weeks of “normal aging” and 2 weeks of “accelerated aging” before testing the antimicrobial efficacy.

In accordance with the present invention, the long-term antimicrobial efficacy of the fibrous substrate can be accomplished in a variety of ways, such as by selectively controlling the nature of the antimicrobial agent, the odor adsorbent, the fibrous substrate, and/or the conditions of use. In one embodiment, for instance, the halogenated antimicrobial agent can be exposed to dilute halogens during use. For example, when incorporated into swimming pants, N-halamines may be exposed to chlorinated and/or brominated swim water while a wearer is in the swimming pool. In this instance, the swim water provides an additional source of free halogen atoms that help maintain the activated state of the activated N-halamine, thereby enhancing the antimicrobial activity of the antimicrobial agent over an extended period of time.

Moreover, in some embodiments, the fibrous substrate to which the antimicrobial agent and odor control agent are applied may be substantially free from superabsorbents conventionally applied to absorbent articles to aid in water absorption. As used herein, the term “superabsorbents” refers to water-swellable, water-insoluble materials capable of absorbing at least about 30 times their weight in water (e.g., 30 grams of water per gram of the superabsorbent). Examples of some conventional superabsorbents, for instance, are described in U.S. Pat. No. 4,798,603 to Meyers, et al., Re. 32,649 to Brandt, et al. and U.S. Pat. No. 4,467,012 to Pedersen, et al., as well as in published European Patent Application 0339461 to Kellenberger. The present inventors have discovered that some superabsorbents affect the antimicrobial efficacy of the antimicrobial agent over an extended period of time. Without intending to be limited by theory, it is believed that superabsorbents can deactivate the halogen oxidant responsible for the antimicrobial efficacy of halogenated antimicrobial agents, such as N-halamines. Thus, by remaining substantially free of superabsorbents, it is believed that the stability of the antimicrobial agent is enhanced. It should be understood that, when referring to a fibrous substrate that is “substantially free” of a superabsorbent, minuscule amounts of the superabsorbent may be present therein. However, such small amounts often arise from the superabsorbent applied to other webs or substrates of the absorbent article, and do not typically substantially affect long-term antimicrobial efficacy.

The present invention may be better understood with reference to the following examples.

### EXAMPLE 1

Various samples (Samples 1-7) were prepared by blending chlorinated polystyrene hydantoin (Poly-1-Cl) with wood pulp fluff. The fluff in the composites was CR1654, from U.S. Alliance in Childersberg, Ala. Poly-1-Cl was supplied by HaloSource Corporation. Sample 1 also contained a superabsorbent particulate material (SAP) available from Dow Chemical of Midland, Mich. under the designation DRYTECH 2035M. In addition, Samples 4-7 contained “Van Gel 0” clay, which is a smectite clay available from R.T. Vanderbilt Company, Inc. of Norwalk, Conn. Samples 1 and 6-7 were produced on a continuous airform line, while the remaining samples were produced on a handsheet former. Particles (superabsorbent, clay, and/or Poly-1-Cl) were mixed with the fluff before forming the web. The amount of the constituents within each sample is set forth below in Table 1 (all amounts are given in grams per meters squared):

TABLE 1
Amount of Sample Constituents

| | | | | Superabsorbent |
|---|---|---|---|---|
| Sample | Fluff | Poly-1-Cl | Clay | Polymer (SAP) |
| 1 | 485 | 15 | 0 | 100 |
| 2 | 600 | 15 | 0 | 0 |
| 3 | 600 | 15 | 0 | 0 |
| 4 | 600 | 15 | 15 | 0 |
| 5 | 600 | 15 | 15 | 0 |
| 6 | 570 | 15 | 15 | 0 |
| 7 | 570 | 15 | 15 | 0 |

The samples were aged for 14 days at a temperature of 130° F. and a relative humidity of 50%. Upon accelerated aging, the samples were tested for antimicrobial activity using MTCC Test Method 100-1999 of the American Association of Textile Chemists and Colorists, which is incorporated by reference, as modified for 3 specified microbes. Briefly, a culture medium (Tryptic Soy Agar) was inoculated with the microorganism and 1 mL of the inoculum was then applied to a 2″ by 2″ piece of the sample. The neutralizer solution was Letheen Broth. The microorganism population (colony forming units (cfu) per mL) was determined at the initial contact time and after a 4-hour contact time at 35-39° C. and a relative midity of around 50%.

Table 2 summarizes the antimicrobial data for each sample, for three types odor-forming bacteria.

TABLE 2
Antimicrobial Data

| | | | | Log Reduction |
|---|---|---|---|---|
| | | Initial | After 4 | after 4 hours |
| Sample | Bacteria | Contact | Hours | (from Initial Contact) |
| 1 | S. aureus | 5.3 × 10⁴ | 5.0 × 10² | 2.0 |
| | E. coli | 6.7 × 10⁵ | 8.3 × 10² | 2.9 |
| | P. mirabilis | 1.9 × 10³ | <1.0 × 10¹ | 2.3 |
| 2 | S. aureus | 3.1 × 10⁴ | <1.0 × 10¹ | 3.5 |
| | E. coli | 4.1 × 10⁴ | <1.0 × 10¹ | 3.6 |
| | P. mirabilis | 4.0 × 10² | <1.0 × 10¹ | 1.6 |
| 3 | S. aureus | 4.3 × 10⁴ | <1.0 × 10¹ | 3.6 |
| | E. coli | 7.1 × 10⁴ | <1.0 × 10¹ | 3.9 |
| | P. mirabilis | 5.2 × 10² | 1.0 × 10¹ | 1.7 |
| 4 | S. aureus | 3.4 × 10⁴ | <1.0 × 10¹ | 3.5 |
| | E. coli | 9.0 × 10⁴ | <1.0 × 10¹ | 4.0 |
| | P. mirabilis | 1.1 × 10³ | <1.0 × 10¹ | 2.0 |
| 5 | S. aureus | 1.5 × 10⁴ | <1.0 × 10¹ | 3.2 |
| | E. coli | 5.4 × 10⁴ | <1.0 × 10¹ | 3.7 |
| | P. mirabilis | 8.0 × 10² | <1.0 × 10¹ | 1.9 |
| 6 | S. aureus | 1.6 × 10⁷ | <1.0 × 10¹ | 6.2 |
| | E. coli | 1.5 × 10⁷ | <1.0 × 10¹ | 6.2 |
| | P. mirabilis | 5.7 × 10⁵ | <1.0 × 10¹ | 4.8 |
| 7 | S. aureus | 1.3 × 10⁷ | <1.0 × 10¹ | 6.1 |
| | E. coli | 1.5 × 10⁷ | <1.0 × 10¹ | 6.2 |
| | P. mirabilis | 1.4 × 10⁷ | <1.0 × 10¹ | 6.1 |

Thus, as indicated above, Samples 2-7 generally contained a higher log reduction after being aged at 14 days at a temperature of 130° F. and a relatively humidity of 50% than Sample 1. It should be noted that, although Samples 1 and 6-7 were formed using a different process than Samples 2-5, such differences are not believed to have substantially affected the log reduction set forth in Table 2.

### EXAMPLE 2

Various samples (Samples 6-11) were prepared by blending chlorinated polystyrene hydantoin (Poly-1-Cl) with wood pulp fluff. The fluff in the composites was CR1654, from U.S. Alliance in Childersberg, Ala. Poly-1-Cl was supplied by HaloSource Corporation. Samples 6-8 also contained a superabsorbent particulate material (SAP) available from Dow Chemical of Midland, Mich. under the designation DRYTECH 2035M. In addition, Samples 9-11 contained “Van Gel 0” clay, which is a smectite clay available from R.T. Vanderbilt Company, Inc. of Norwalk, Conn. Samples 6-11 were produced on a continuous airform line. Particles (superabsorbent, clay, and/or Poly-1-Cl) were delivered by a Christy feeder to the forming chamber where mixing with the fluff occurred, followed by web formation on the wire. The amount of the constituents within each sample is set forth below in Table 3 (all amounts are given in grams per meters squared):

TABLE 3
Amount of Sample Constituents

| | | | | Superabsorbent |
|---|---|---|---|---|
| Sample | Fluff | Poly-1-Cl | Clay | Polymer (SAP) |
| 6 | 485 | 15 | 0 | 100 |
| 7 | 485 | 15 | 0 | 100 |
| 8 | 485 | 15 | 0 | 100 |
| 9 | 570 | 15 | 15 | 0 |
| 10 | 570 | 15 | 15 | 0 |
| 11 | 570 | 15 | 15 | 0 |

After 6 weeks of normal aging (stored at room temperature and at a humidity of 50%), the samples were further aged (accelerated or normal) at low and high humidities as set forth below in Table 4.

TABLE 4
Aging Conditions

| | | | Relative Humidity |
|---|---|---|---|
| Sample | Time (weeks) | Temperature (° F.) | (%) |
| 6 | 2 | 70 | 50 |
| 7 | 2 | 130 | <10 |
| 8 | 2 | 130 | 50 |
| 9 | 2 | 70 | 50 |
| 10 | 2 | 130 | <10 |
| 11 | 2 | 130 | 50 |

The aged samples were then tested for antimicrobial activity as set forth above in Example 1. Table 5 summarizes the antimicrobial data for each sample, for three types of odor-forming bacteria. Duplicate samples from each code were given unique labels. One of the samples from each code was labeled with a number and the other sample was labeled with a letter. The tester challenged pieces (2″ by 2″) from each letter-labeled sample with the 3 microbes (one microbe per piece) on the same day and all number-labeled samples on a different day. Therefore, each of the two readings shown in the table for the three microbes represents a separate experiment.

TABLE 5
Antimicrobial Data

| | | | | Log Reduction |
|---|---|---|---|---|
| | | Initial | After | after 4 hours |
| Sample | Bacteria | Contact | 4 Hours | (from Initial Contact) |
| 6 | S. aureus | 1.3 × 10⁷ | 4.4 × 10³ | 3.5 |
| | | 1.9 × 10⁷ | 9.7 × 10² | 4.3 |
| | E. coli | 1.4 × 10⁷ | 6.7 × 10² | 4.3 |
| | | 1.5 × 10⁷ | 5.5 × 10¹ | 5.4 |
| | P. mirabilis | 1.2 × 10⁶ | <1.0 × 10¹ | 5.1 |
| | | 2.9 × 10⁵ | 8.0 × 10² | 2.6 |
| 7 | S. aureus | 1.3 × 10⁷ | <1.0 × 10¹ | 6.1 |
| | | 2.0 × 10⁷ | 1.5 × 10² | 5.1 |
| | E. coli | 2.2 × 10⁷ | <1.0 × 10¹ | 6.3 |
| | | 1.9 × 10⁷ | 8.0 × 10¹ | 5.4 |
| | P. mirabilis | 6.5 × 10⁵ | 1.5 × 10¹ | 4.6 |
| | | 1.8 × 10⁶ | <1.0 × 10¹ | 5.3 |
| 8 | S. aureus | 2.0 × 10⁷ | 4.5 × 10¹ | 5.6 |
| | | 2.4 × 10⁷ | 4.4 × 10⁵ | 1.7 |
| | E. coli | 1.5 × 10⁷ | 2.2 × 10⁵ | 1.8 |
| | | 3.1 × 10⁷ | 2.4 × 10² | 5.1 |
| | P. mirabilis | 1.1 × 10⁶ | <1.0 × 10¹ | 5.0 |
| | | 2.6 × 10⁶ | 1.0 × 10¹ | 5.4 |
| 9 | S. aureus | 1.6 × 10⁷ | 2.5 × 10¹ | 5.8 |
| | | 9.9 × 10⁶ | 1.5 × 10¹ | 5.8 |
| | E. coli | 1.2 × 10⁷ | 2.0 × 10¹ | 5.8 |
| | | 1.6 × 10⁷ | 9.0 × 10¹ | 5.2 |
| | P. mirabilis | 9.1 × 10⁵ | 1.6 × 10² | 3.8 |
| | | 1.4 × 10⁶ | 3.0 × 10¹ | 4.7 |
| 10 | S. aureus | 5.8 × 10⁶ | <1.0 × 10¹ | 5.8 |
| | | 5.1 × 10⁶ | <1.0 × 10¹ | 5.7 |
| | E. coli | 1.6 × 10⁷ | 6.5 × 10¹ | 5.4 |
| | | 1.3 × 10⁷ | <1.0 × 10¹ | 6.1 |
| | P. mirabilis | 4.3 × 10⁵ | <1.0 × 10¹ | 4.6 |
| | | 1.5 × 10⁶ | <1.0 × 10¹ | 5.2 |
| 11 | S. aureus | 1.6 × 10⁷ | <1.0 × 10¹ | 6.2 |
| | | 1.3 × 10⁷ | <1.0 × 10¹ | 6.1 |
| | E. coli | 1.5 × 10⁷ | <1.0 × 10¹ | 6.2 |
| | | 1.5 × 10⁷ | <1.0 × 10¹ | 6.2 |
| | P. mirabilis | 5.7 × 10⁵ | <1.0 × 10¹ | 4.8 |
| | | 1.4 × 10⁷ | <1.0 × 10¹ | 6.1 |

Thus, as indicated above, Samples 9-11 generally contained a higher log reduction after aging than Samples 6-8.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A fibrous substrate applied with a halogenated antimicrobial agent in an amount from about 0.1% to about 10% by weight of said substrate and an odor adsorbent in an amount of 0.5% to about 20% by weight of said substrate, wherein after being aged at a temperature of 130° F. and a relative humidity of 50% for 2 weeks, said fibrous substrate exhibits a log reduction for E. coli, S. aureus, P. mirabilis, or combinations thereof, of at least about 3, measured after a contact period of 4 hours.

2. A fibrous substrate as defined in claim 1, wherein said halogenated antimicrobial agent is selected from the group consisting of N-halamines, iodinated resins, and combinations thereof.

3. A fibrous substrate as defined in claim 1, wherein said halogenated antimicrobial agent is an N-halamine compound.

4. A fibrous substrate as defined in claim 3, wherein said N-halamine compound is obtained from a 1,3-dimethylol-5,5-dimethyl hydantoin precursor.

5. A fibrous substrate as defined in claim 3, wherein said N-halamine compound is obtained from a polystyrene hydantoin precursor.

6. A fibrous substrate as defined in claim 3, wherein said N-halamine compound has the following formula: 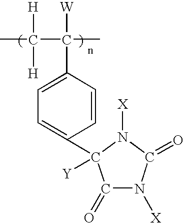
wherein,
W=hydrogen or CH₃;
X=hydrogen, a halogen atom, or a C₁-C₄ alkyl group; and
Y=a C₁-C₄ alkyl group.

7. A fibrous substrate as defined in claim 3, wherein said N-halamine compound is poly[1,3-dichloro-5-methyl-5(4′-vinylphenyl) hydantoin.

8. A fibrous substrate as defined in claim 1, wherein said odor adsorbent is selected from the group consisting of activated carbon, zeolites, silica, cyclodextrin and derivatives thereof, and combinations thereof.

9. A fibrous substrate as defined in claim 1, wherein said antimicrobial agent constitutes from about 0.5% to about 5% of said fibrous substrate.

10. A fibrous substrate as defined in claim 1, wherein said odor adsorbent constitutes from about 1% to about 10% of said fibrous substrate.

11. A fibrous substrate as defined in claim 1, wherein said fibrous substrate is a nonwoven web.

12. A fibrous substrate as defined in claim 1, wherein after being aged at a temperature of 130° F. and a relative humidity of 50% for 2 weeks, said fibrous substrate exhibits a log reduction for E. coli, S. aureus, P. mirabilis, or combinations thereof, of at least about 3.5, measured after a contact period of 4 hours.

13. A fibrous substrate as defined in claim 1, wherein after being aged at a temperature of 130° F. and a relative humidity of 50% for 2 weeks, said fibrous substrate exhibits a log reduction for E. coli, S. aureus, P. mirabilis, or combinations thereof, of at least about 4, measured after a contact period of 4 hours.

14. A fibrous substrate as defined in claim 1, wherein said fibrous substrate is substantially free from superabsorbents.

15. A nonwoven web applied with an N-halamine compound in an amount from about 0.1% to about 10% by weight of said nonwoven web and an odor adsorbent in an amount of 0.5% to about 20% by weight of said nonwoven web, said nonwoven web being substantially free from superabsorbents, wherein after being aged at a temperature of 130° F. and a relative humidity of 50% for 2 weeks, said nonwoven web exhibits a log reduction for E. coli, S. aureus, P. mirabilis, or combinations thereof, of at least about 3, measured after a contact period of 4 hours.

16. A nonwoven web as defined in claim 15, wherein said N-halamine compound is obtained from a 1,3-dimethylol-5,5-dimethyl hydantoin precursor.

17. A nonwoven web as defined in claim 15, wherein said N-halamine compound is obtained from a polystyrene hydantoin precursor.

18. A nonwoven web as defined in claim 15, wherein said N-halamine compound has the following formula: 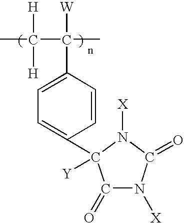
wherein,
W hydrogen or CH₃;
X=hydrogen, a halogen atom, or a C₁-C₄ alkyl group; and
Y=a C₁-C₄ alkyl group.

19. A nonwoven web as defined in claim 15, wherein said N-halamine compound is poly[1,3-dichloro-5-methyl-5(4′-vinylphenyl) hydantoin.

20. A nonwoven web as defined in claim 15, wherein said odor adsorbent is selected from the group consisting of activated carbon, zeolites, silica, cyclodextrin and derivatives thereof, and combinations thereof.

21. A nonwoven web as defined in claim 15, wherein said N-halamine compound constitutes from about 0.5% to about 5% of said nonwoven web.

22. A nonwoven web as defined in claim 15, wherein said odor adsorbent constitutes from about 1% to about 10% of said nonwoven web.

23. A nonwoven web as defined in claim 15, wherein after being aged at a temperature of 130° F. and a relative humidity of 50% for 2 weeks, said nonwoven web exhibits a log reduction for E. coli, S. aureus, P. mirabilis, or combinations thereof, of at least about 3.5, measured after a contact period of 4 hours.

24. A nonwoven web as defined in claim 15, wherein after being aged at a temperature of 130° F. and a relative humidity of 50% for 2 weeks, said nonwoven web exhibits a log reduction for E. coli, S. aureus, P. mirabilis, or combinations thereof, of at least about 4, measured after a contact period of 4 hours.

25. A personal care absorbent article that comprises at least one liquid-transmissive layer and a liquid-absorbent core, wherein a nonwoven web forms at least a portion of said liquid-transmissive layer, said liquid-absorbent core, or combinations thereof, wherein said nonwoven web is applied with an N-halamine compound and an odor adsorbent, wherein after being aged at a temperature of 130° F. and a relative humidity of 50% for 2 weeks, said nonwoven web exhibits a log reduction for E. coli, S. aureus, P. mirabilis, or combinations thereof, of at least about 3, measured after a contact period of 4 hours.

26. A personal care absorbent article as defined in claim 25, wherein said nonwoven web is substantially free from superabsorbents,

27. A personal care absorbent article as defined in claim 25, wherein said N-halamine compound constitutes from about 0.1% to about 10% of said nonwoven web.

28. A personal care absorbent article as defined in claim 25, wherein said N-halamine compound constitutes from about 0.5% to about 5% of said nonwoven web.

29. A personal care absorbent article as defined in claim 25, wherein said odor adsorbent constitutes from about 0.5% to about 20% of said nonwoven web.

30. A personal care absorbent article as defined in claim 25, wherein said odor adsorbent constitutes from about 1% to about 10% of said nonwoven web.

31. A personal care absorbent article as defined in claim 25, wherein said N-halamine compound is obtained from a 1,3-dimethylol-5,5-dimethyl hydantoin precursor.

32. A personal care absorbent article as defined in claim 25, wherein said N-halamine compound is obtained from a polystyrene hydantoin precursor.

33. A personal care absorbent article as defined in claim 25, wherein said N-halamine compound has the following formula: 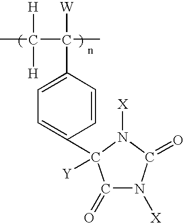
wherein,
W hydrogen or CH₃;
X=hydrogen, a halogen atom, or a C₁-C₄ alkyl group; and
Y=a C₁-C₄ alkyl group.

34. A personal care absorbent article as defined in claim 25, wherein said N-halamine compound is poly[1,3-dichloro-5-methyl-5(4′-vinylphenyl) hydantoin.

35. A personal care absorbent article as defined in claim 25, wherein said odor adsorbent is selected from the group consisting of activated carbon, zeolites, silica, cyclodextrin and derivatives thereof, and combinations thereof.

36. A personal care absorbent article as defined in claim 25, wherein after being aged at a temperature of 130° F. and a relative humidity of 50% for 2 weeks, said nonwoven web exhibits a log reduction for E. coli, S. aureus, P. mirabilis, or combinations thereof, of at least about 3.5, measured after a contact period of 4 hours.

37. A personal care absorbent article as defined in claim 25, wherein after being aged at a temperature of 130° F. and a relative humidity of 50% for 2 weeks, said nonwoven web exhibits a log reduction for E. coli, S. aureus, P. mirabilis, or combinations thereof, of at least about 4, measured after a contact period of 4 hours.

38. A personal care absorbent article as defined in claim 25, wherein the personal care absorbent article includes a liquid-transmissive liner, a liquid-transmissive surge layer, a liquid-absorbent core, and a vapor-permeable, liquid-impermeable outer cover, said nonwoven web forming at least a portion of said liner, said surge layer, said absorbent core, or combinations thereof.
